(19) United States
(12) Patent Application Publication
(10) Pub. No.: US 2021/0227034 A1
(43) Pub. Date: Jul. 22, 2021

(54) A METHOD AND SYSTEM FOR TRANSMITTING STREAMING MEDIA RESOURCES

(71) Applicant: WANGSU SCIENCE & TECHNOLOGY CO., LTD., Shanghai (CN)

(72) Inventors: Shuang ZOU, Shanghai (CN); Shibiao LV, Shanghai (CN)

(21) Appl. No.: 16/099,850

(22) PCT Filed: May 9, 2018
(86) PCT No.: PCT/CN2018/086180

§ 371 Date: Nov. 8, 2018

(30) Foreign Application Priority Data
Apr. 18, 2018 (CN) 201810350528.X

(51) Int. Cl. H04L 29/08; H04L 29/06

(52) U.S. Cl. CPC H04L 67/16; H04L 67/18; H04L 65/1069; H04L 67/1023; H04L 65/4084

(57) ABSTRACT

A method for transmitting streaming media resources includes: receiving a processing request for a target streaming media resource sent by a client, and dispatching the processing request to a first process; forwarding the processing request to a second process in a layer in which the first process is located; constructing, through the second process, a response request corresponding to the processing request, wherein the response request includes an access address generated by the second process for accessing the target streaming media resource; and feeding back the response request to the first process, and feeding back the response request to the client through the first process, to allow the client to establish a connection with the second process, and the target streaming media resource to be transmitted through the established connection.

### FIELD OF DISCLOSURE

The present disclosure generally relates to the field of Internet technology and, more particularly, relates to a method and system for transmitting streaming media resources.

### BACKGROUND

WebRTC (Web Real-Time Communication) protocol is widely used in network-based video conferencing, video calling, and other application scenarios due to its cross-platform structure and high real-time performance.

Referring to FIG. 1, in the standard WebRTC protocol, a peer-to-peer communication link may be usually established between user A and user B. The specific process may include the following steps:

Step 1: User A sends a query to the P2P server to obtain its own public network address.

Step 2: User A generates an Offer SDP according to the streaming media information collected by the hardware of user A, and sends the Offer SDP to user B through the relay of the signaling server.

Step 3: User B receives and processes the Offer SDP, generates an Answer SDP according to the streaming media information collected by the hardware of user B, and sends the Answer SDP to user A through the relay of the signaling server.

Step 4: User B sends a query to the P2P server to obtain its own public network address.

Step 5: User A generates an ICE Candidate according to its public network address, and transmits the generated ICE Candidate to user B through the relay of the signaling server.

Step 6: User B generates an ICE Candidate according to its public network address, and transmits the generated ICE Candidate to user A through the relay of the signaling server.

Step 7: Both user A and user B can send their own streaming media to the other party according to the exchanged SDP and ICE Candidate, and receive the streaming media sent by the other party.

It can be seen from the above that WebRTC provides a peer-to-peer communication method. The establishment of this communication method requires a complicated process. At the same time, this communication method is incompatible with many existing network architectures. For example, in a Content Delivery Network (CDN), the communication is usually based on RTMP (Real Time Messaging Protocol) and HTTP (HyperText Transfer Protocol). In order to enable a large number of terminal devices to view streaming media resources with a low delay, there is a need of a technology for applying the WebRTC standards to a CDN to improve the transmission efficiency of streaming media resources.

### BRIEF SUMMARY OF THE DISCLOSURE

The present disclosure provides a method and system for transmitting streaming media resources, which improve the transmission efficiency of the streaming media resources.

To achieve the above objective, in one aspect, the present disclosure provides a method for transmitting streaming media resources. The method includes: receiving a processing request for a target streaming media resource sent by a client, dispatching the processing request to a first process; determining whether it is the first process to process the processing request, if it is not the first process to process the processing request, forwarding the processing request to a second process in a layer in which the first process is located; determining whether it is the second process to process the processing request, if it is the second process to process the processing request, constructing, through the second process, a response request corresponding to the processing request, where the response request includes an access address generated by the second process for accessing the target streaming media resource; feeding back the response request to the first process, and feeding back the response request to the client through the first process, to allow the client to establish a connection with the second process, and the target streaming media resource to be transmitted through the established connection.

To achieve the above objective, in another aspect, the present disclosure provides a system for transmitting streaming media resources. The system includes a client and an edge node, where: the client is configured to send a processing request for a target streaming media resource to the edge node; and the edge node is configured to dispatch the processing request to a first process, determine whether it is the first process to process the processing request, if it is not the first process to process the processing request, forward the processing request to a second process in a layer in which the first process is located, determine whether it is the second process to process the processing request, if it is the second process to process the processing request, construct, through the second process, a response request corresponding to the processing request, where the response request includes an access address generated by the second process for accessing the target streaming media resource, feed back the response request to the first process, and feed back the response request to the client through the first process, to allow the client to establish a connection with the second process, and the target streaming media resource to be transmitted through the established connection.

As can be seen from the above, in the technical solutions provided by the present disclosure, the HTTP protocol and the WebRTC protocol may be integrated, which simplifies the process of establishing communication connection, and can also adapt to the routing and forwarding regulations in the CDN. Multiple layers may be included in a CDN, such as an access layer (edge nodes), a relay layer (parent nodes), a core layer (source nodes), and the like. Routing or forwarding is usually involved within or between layers. Specifically, when a first process in a certain layer receives a processing request sent by a client, according to the routing rule in the CDN, it may be determined whether the processing request should be processed by the first process. If the processing request should not be processed by the first process, according to the routing rule, the processing request may be forwarded to a second process in the same layer. The second process may construct a response request for the processing request, where the response request may include an ICE candidate generated by the second process, and the ICE candidate may serve as an access address for accessing a target streaming media resource. After the response request is fed back to the client through the first process, a WebRTC communication connection may be established between the client and the second process. The client may upload the streaming media resource to the second process or obtain the streaming media resource from the second process. Further, if the second process still cannot process the processing request, the processing request may be forwarded to a third process in a next layer. The third process may construct a response request in a similar manner, except that the access address included in the response request is generated by the third process. After the response request is fed back to the second process, the second process may rewrite the access address therein into its own access address, and feed back the response request with the rewritten access address to the client through the first process. In this way, the client and the second process, and the second process and the third process may respectively establish a WebRTC connection, and thus the streaming media resource can be transmitted. It can be seen that the technical solutions provided by the present disclosure may effectively combine the WebRTC standards with the CDN, which can utilize the fast distribution function of the CDN, while also achieving the low delay performance of the WebRTC, thereby improving the transmission efficiency of the streaming media resources.

### BRIEF DESCRIPTION OF THE DRAWINGS

To make the technical solutions in the embodiments of the present disclosure clearer, a brief introduction of the accompanying drawings consistent with descriptions of the embodiments will be provided hereinafter. It is to be understood that the following described drawings are merely some embodiments of the present disclosure. Based on the accompanying drawings and without creative efforts, persons of ordinary skill in the art may derive other drawings.

FIG. 1 is an interactive diagram of a standard WebRTC process in the prior art;

FIG. 2 is a flowchart of a method for transmitting streaming media resources according to some embodiments of the present disclosure;

FIG. 3 is an interactive diagram of a method for transmitting streaming media resources according to some embodiments of the present disclosure;

FIG. 4 is an interactive diagram of a method for uploading a streaming media resource according to some embodiments of the present disclosure;

FIG. 5 is an interactive diagram of a method for downloading a streaming media resource according to some embodiments of the present disclosure;

FIG. 6 is a flowchart of another method for transmitting streaming media resources according to some embodiments of the present disclosure;

FIG. 7 is a schematic diagram of an application scenario for transmitting streaming media resources according to some embodiments of the present disclosure; and

FIG. 8 is a schematic structural diagram of a computer terminal according to some embodiments of the present disclosure.

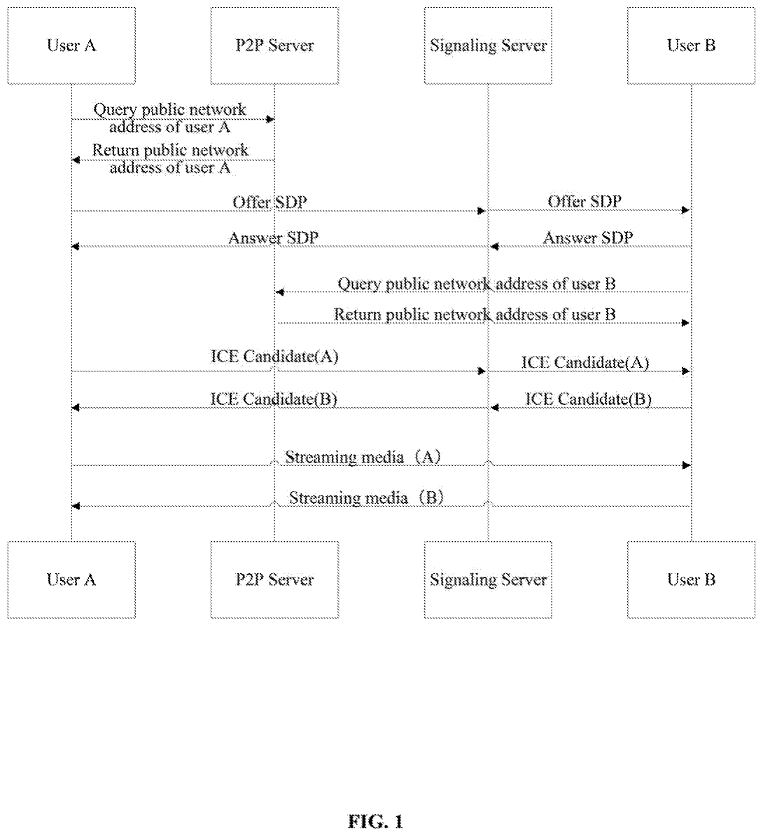

### DETAILED DESCRIPTION

To make the objective, technical solutions, and advantages of the present disclosure clearer, the present disclosure will be made in detail hereinafter with reference to the accompanying drawings.

### Embodiment 1

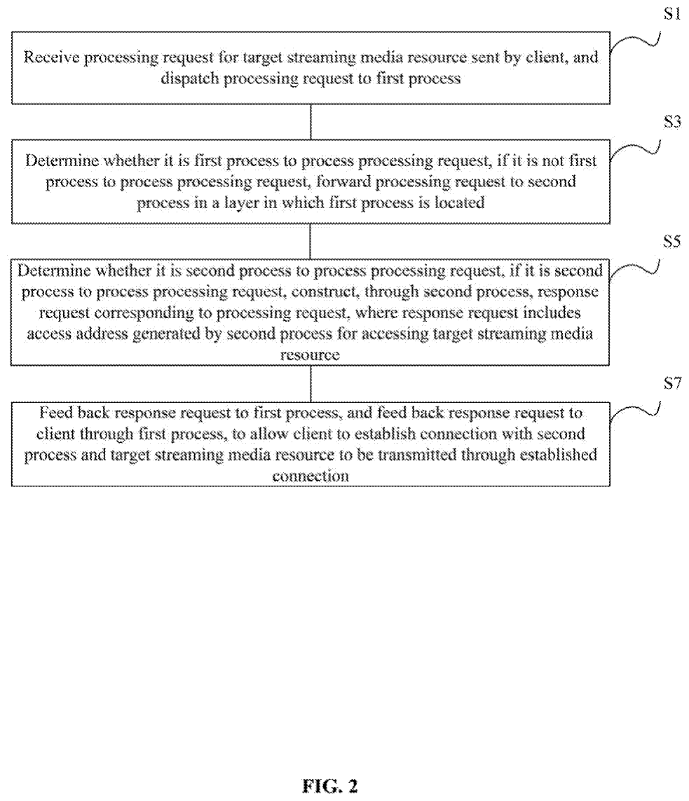

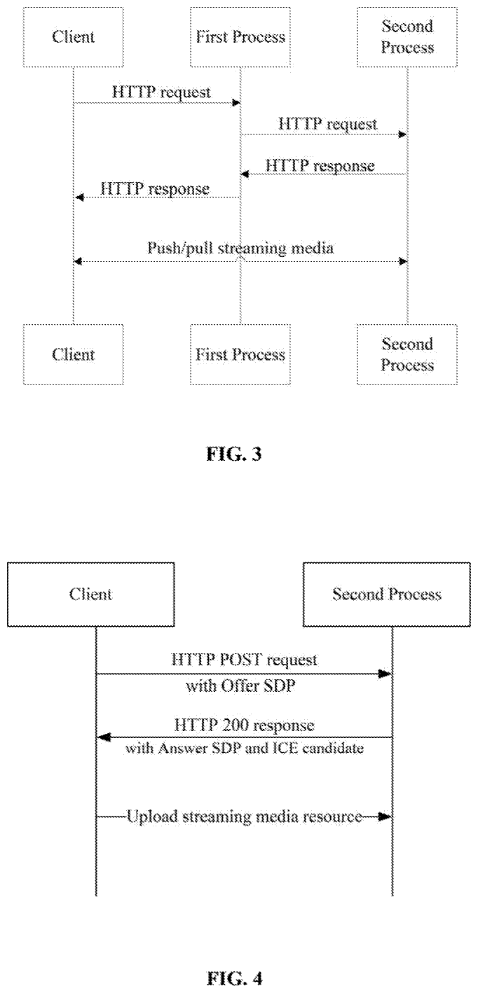

The present disclosure provides a method for transmitting streaming media resources, which may be applied to a CDN. Referring to FIG. 2 and FIG. 3, the method may include the following steps.

S1: receive a processing request for a target streaming media resource sent by a client, and dispatch the processing request to a first process.

In the disclosed embodiment, when a client needs to upload or download a target streaming media resource, a processing request for the target streaming media resource may be initiated, where the processing request may include a resource acquisition request and a resource uploading request. In the disclosed embodiment, each streaming media resource may have a unique identifier. The rule for naming a unique identifier may not be limited here, as long as the corresponding streaming media resource can be uniquely identified. In real applications, a unique identifier may be a Uniform Resource Locator (URL). In the disclosed embodiment, the naming rule of a URL may be consistent with the naming rules of URLs of the streaming media resources in RTMP and HTTP. For example, the URL of a streaming media resource may be http://www.a.com/live/test.

In the disclosed embodiment, the processing request sent by the client may be an HTTP POST request or an HTTP GET request. The processing request may be received by a load balancing server in the CDN and distributed to an edge server in the edge node by the load balancing server. The load balancing server may distribute the processing request according to a preset load balancing policy. For example, the processing request may be dispatched to an edge server whose current load is lowest. In the edge server, the received requests are typically processed by processes. Accordingly, the processing request may be dispatched to a first process in the edge server.

S3: determine whether it is the first process to process the processing request, and if it is not the first process to process the processing request, forward the processing request to a second process in a layer in which the first process is located.

Multiple layers may be included in a CDN, such as an access layer (edge nodes), a relay layer (parent nodes), a core layer (source nodes), and the like. The processing requests sent by the clients are usually transferred within or between layers depending on the real situations. Accordingly, a CDN may have certain routing rule that defines a processing request sent by the client should be processed by which process in which layer. Accordingly, after receiving the processing request dispatched by the load balancing server, the first process may determine, according to the routing rule, whether the processing request should be processed by itself. In the disclosed embodiment, the expression of the routing rule may be different for different processing requests. For example, for a resource acquisition request, the routing rule may be expressed as: determining whether the target streaming media resource is included in the local resource associated with the first process; if the target streaming media resource is included in the local resource associated with the first process, it may be determined that the processing request is processed by the first process; if the target streaming media resource is not included in the local resource associated with the first process, it may be determined that the processing request will not be processed by the first process. For another example, for a resource uploading request, the routing rule may be expressed as: calculating a hash value corresponding to a unique identifier based on the unique identifier of the target streaming media resource included in the resource uploading request. In real applications, a hash algorithm may be used to calculate the hash value of the URL of a target streaming media resource. The calculated hash value may be the foregoing hash value. In the disclosed embodiment, each process may associate in advance with a certain number of hash values. Accordingly, after the hash value of a unique identifier is calculated, it may be determined whether a process associated with the hash value is the first process. If the process associated with the hash value is the first process, it means that the hash value signifies the first process, then it may be determined that the processing request is to be processed by the first process. If the process associated with the hash value is not the first process, it means that the hash value does not signify the first process, then it may be determined that the processing request will not be processed by the first process.

In the disclosed embodiment, if the first process is not responsible for processing the processing request, the processing request may be forwarded to a second process in the same layer according to the routing rule.

S5: determine whether it is the second process to process the processing request, and if it is the second process to process the processing request, construct, through the second process, a response request corresponding to the processing request, where the response request includes an access address generated by the second process for accessing the target streaming media resource.

In the disclosed embodiment, after receiving the processing request, the second process may also determine, according to the routing rule, whether the processing request is to be processed by itself. If the routing rule indicates that the second process still cannot process the processing request, it means that all the processes in that layer cannot process the request. In that case, the request may be forwarded to another layer. For example, a client in Shanghai initiates a request to download a streaming media resource. The request is dispatched by the load balancing server to an idle first process in the edge node. By calculating the hash value corresponding to the request, it indicates that the request should actually be processed by the second process in the edge node. Accordingly, the processing request may be forwarded to the second process. However, in the local resource associated with the second process, there is no streaming media resource that the client wants to download. Therefore, the second process cannot process the request. At this point, the request may be forwarded to another process in the core layer, and the request is processed by such process in the core layer.

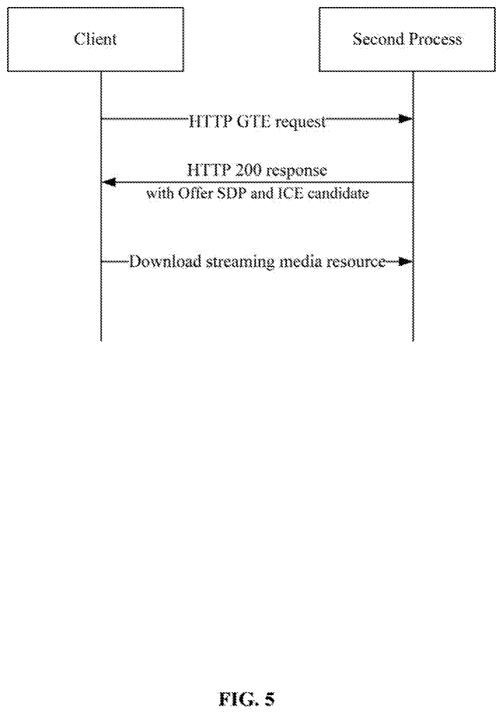

In the disclosed embodiment, if the second process determines that the request may be processed by itself, the second process may attempt to establish a WebRTC communication connection with the client. The target streaming media resource may be transmitted later through the established WebRTC communication connection. In the disclosed embodiment, the process of establishing a WebRTC communication connection may be different for different processing requests. Referring to FIG. 4, when a client needs to upload a target streaming media resource to the second process, a resource uploading request may be initiated. At this time, the client may first generate an Offer SDP based on the streaming media information collected by its own hardware. In the Offer SDP, information supported by the client, such as the video encoding modes, the audio encoding modes, and whether the audio/video is encrypted, may be included. For instance, a simple example of an Offer SDP may be as follows:

Offer SDP {
Now send a media stream resource;
Video coding may use H264, VP8, VP9;
Audio coding may use AAC, MP3, OPUS;
Encryption may be enabled;
}

As can be seen from the above, in the Offer SDP, a plurality of video encoding modes and a plurality of audio encoding modes supported by the client may be listed. Accordingly, the generated Offer SDP may include the above-listed candidate streaming media information.

In the disclosed embodiment, the resource uploading request sent by a client may be, for example, an HTTP POST request. The request message body of the request may be the Offer SDP described above. Accordingly, the resource uploading request may include candidate streaming media information supported by the client.

In the disclosed embodiment, after receiving the resource uploading request, the second process may extract the included candidate streaming media information from the request. Next, based on its own hardware configuration, the second process may determine, from the candidate streaming media information, a target video coding mode and a target audio coding mode supported by the second process itself, and construct a response streaming media information based on the target video coding mode and the target audio coding mode. For example, the second process may determine that it is able to accept the target streaming media resource to be uploaded by the client at this moment, and specify that the video encoding mode is H264, the audio encoding mode is OPUS, and the target streaming media resource may be encrypted. Accordingly, an example of the response streaming media information generated by the second process, Answer SDP, may be as follows:

Answer SDP {
Can receive the media stream you sent;
Please use H264 for video encoding;
Please use OPUS for audio coding;
Please enable encryption;
}

In the disclosed embodiment, in order to establish a WebRTC connection, besides the SDP information, ICE candidate information is also required. ICE candidate information may be constructed based on a public network IP address. Specifically, the second process may obtain its own public network IP address and port address. The public network IP address may be stored in the edge server where the second process is located, without being read from other servers. The second process may then use a combination of the public network IP address and the port address as an access address for accessing the target streaming media resource. For example, the public network IP address may be 10.8.114.195, and the port address for receiving the streaming media resource may be 54225. The eventually generated access address may be 10.8.114.195:54225. This access address may be used as the ICE candidate. In this way, the second process may obtain the response streaming media information (Answer SDP) and the access address (ICE candidate) required to establish the WebRTC communication connection.

In the disclosed embodiment, the second process may construct a response message in response to the received resource uploading request. The response message may be an HTTP response message with a status code of 200. The response streaming media information and the access address may be included in the response message body of the response message.

In one embodiment, referring to FIG. 5, the processing request may be a resource acquisition request. A client may download a target streaming media resource by initiating a resource acquisition request. The resource acquisition request may be, for example, an HTTP GET request. The URL of the request may be the unique identifier of the target streaming media resource. After receiving the resource acquisition request, the second process may determine the target streaming media resource that the client wants to download from the associated local resource according to the unique identifier included in the request. At this moment, the second process may obtain its own public network IP address and port address. The public network IP address may be stored in the edge server where the second process is located, without being read from other servers. The second process may use a combination of the public network IP address and the port address as an access address for accessing the target streaming media resource. For example, the public network IP address may be 10.8.114.195, and the port address for transmitting the streaming media resource may be 54225, and the eventually generated access address may be 10.8.114.195:54225. This access address may be used as the ICE candidate required to establish the WebRTC communication connection.

In the disclosed embodiment, the streaming media resources in the local resource associated with the second process may be uploaded by other clients. After a client uploads a streaming media resource, the second process may associate and store the streaming media resource with the corresponding response streaming media information. In this way, based on the unique identifier of the target streaming media resource, the second process may query the response stream media information associated with the unique identifier, and use the response streaming media information as the target streaming media information associated with the target streaming media resource. Accordingly, the second process may use the target streaming media information as an Offer SDP. In this way, the second process generates the Offer SDP and the ICE candidate. At this point, the second process may construct a response message, which may be, for example, an HTTP response message with a status code of 200. The response message body of the response message may include the above-mentioned access address (ICE candidate) and the target streaming media information (Offer SDP) associated with the target streaming media resource.

S7: feed back the response request to the first process, and feed back the response request to the client through the first process, to allow the client to establish a connection with the second process, and the target streaming media resource to be transmitted through the established connection.

In the disclosed embodiment, after the second process constructs the response request corresponding to the processing request, the response request may be fed back to the first process. The first process may continue to forward the response request to the client. In this way, with the SDP information and the ICE candidate, a WebRTC communication connection may be established between the client and the second process.

In the disclosed embodiment, the target streaming media resource may be transmitted between the client and the second process through the established WebRTC communication connection. Specifically, for a resource uploading request, the client may process the target streaming media resource according to the response streaming media information, and upload the processed target streaming media resource to the second process according to the access address. For a resource acquisition request, the client may download the target streaming media resource through the access address, and process the downloaded target streaming media resource by using the target streaming media information.

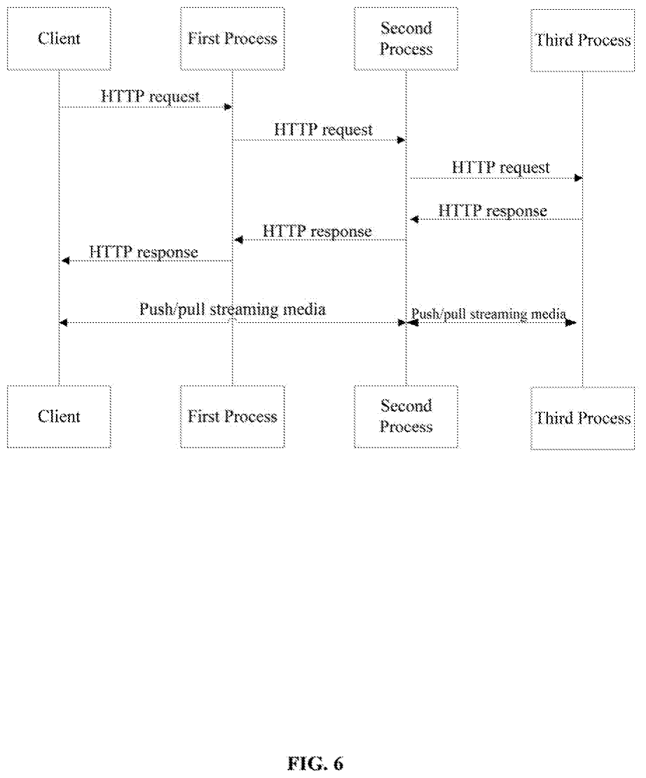

In one embodiment, referring to FIG. 6, if the second process cannot process the processing request, the processing request may be forwarded to a load balancing server in another layer according to the routing rule. Afterwards, the load balancing server of that layer may dispatch the processing request to a third process. Here, the first process and the second process are located in the same layer, while the third process is located in a different layer.

In the disclosed embodiment, after receiving the processing request, the third process may also determine whether it can process the request according to the routing rule. If the third process can process the request, the third process may construct a response request corresponding to the processing request. The manner in which the response request is constructed is similar to that described above, and different response requests may be constructed for different processing requests. For example, the processing request may include a resource uploading request, and the resource uploading request may include candidate streaming media information supported by the client. When the third process constructs the response request corresponding to the processing request, the response streaming media information may be generated based on the candidate streaming media information and its own hardware configuration of the third process. Thereafter, the third process may obtain its own public network IP address and port address, and use the combination of the public network IP address and the port address as the access address for accessing the target streaming media resource. Based on the response streaming media information and the access address, the third process may construct the response request, and use the response streaming media information and the access address as the response message body of the response request.

Further, for a resource acquisition request, the resource acquisition request may include a unique identifier of the target streaming media resource. The third process may acquire the target streaming media information associated with the unique identifier when constructing the response request corresponding to the processing request. At the same time, the third process may also obtain its own public network IP address and port address, and use the combination of the public network IP address and the port address as the access address for accessing the target streaming media resource. In this way, the third process may construct the response request, and use the target streaming media information and the access address as the response message body of the response request.

In the disclosed embodiment, after constructing the response request, the third process may feed back the constructed response request to the second process. The response request received by the second process includes the SDP information and the ICE candidate, so the second process may establish a WebRTC communication connection with the third process.

In the disclosed embodiment, after receiving the response request sent by the third process, the second process may obtain its own public network IP address and port address, and use the combination of the public network IP address and the port address as the access address generated by the second process. Thereafter, the second process may rewrite the access address in the response request constructed by the third process to the access address generated by the second process, and feed back the response request with the rewritten access address to the client. The response request received by the client includes the SDP information and the ICE candidate of the second process, which allows the client to establish a WebRTC communication connection with the second process. In this way, the target streaming media resource may be subsequently transmitted through the connection established between the client and the second process and the connection established between the second process and the third process. Specifically, for a resource uploading request, the client may process the target streaming media resource according to the response streaming media information, and upload the processed target streaming media resource to the second process according to the access address generated by the second process. The second process may associate and store the processed target streaming media resource with the response streaming media information, and upload the processed target streaming media resource to the third process according to the access address generated by the third process. Similarly, the third process may also associate and store the processed target streaming media resource with the response streaming media information. In this way, the resources associated with the second process and the third process may each include the uploaded target streaming media resource.

In addition, for a resource acquisition request, the second process may first download the target streaming media resource from the third process according to the access address generated by the third process, and associate and store the downloaded target streaming media resource with the target streaming media information. Then, the client may download the target streaming media resource from the second process according to the access address generated by the second process, to finish the resource downloading process.

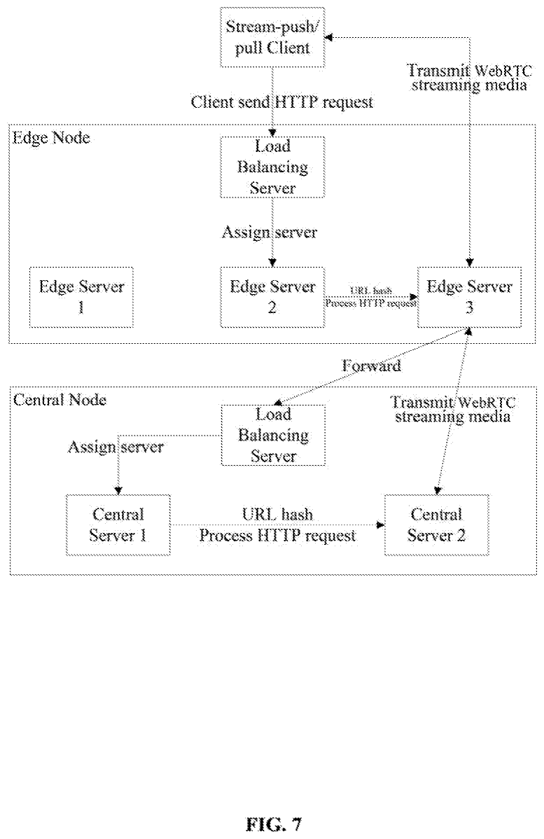

It should be noted that, after the determination based on the routing rule, the third process may also be unable to process the processing request. At this point, the processing request may be further forwarded to a fourth process in the same layer as the third process. Specifically, referring to FIG. 7, in the scenario shown in FIG. 7, a processing request sent by the client sequentially goes through the edge server 2 (the first process) and the edge server 3 (the second process) in the edge node, and after through the central server 1 (the third process) in the central node, the request reaches the central server 2 (the fourth process) that is able to process the request. In this case, the fourth process may construct a response request corresponding to the processing request in the above-described manner, where the response request includes an access address generated by the fourth process for accessing the target streaming media resource. The response request constructed by the fourth process may be then fed back to the second process through the third process, to allow the second process to establish a connection with the fourth process. At this point, the second process may rewrite the access address in the response request constructed by the fourth process to the access address generated by the second process, and feed back the response request with the rewritten access address to the client, to allow the client to establish a connection with the second process. In this way, the target streaming media resource may be subsequently transmitted through the connection established between the client and the second process and the connection established between the second process and the fourth process.

### Embodiment 2

The present disclosure further provides a system for transmitting streaming media resources. The system includes a client and an edge node, where:

the client is configured to send a processing request for a target streaming media resource to the edge node; and

the edge node is configured to dispatch the processing request to a first process, determine whether it is the first process to process the processing request, if it is not the first process to process the processing request, forward the processing request to a second process in a layer in which the first process is located, determine whether it is the second process to process the processing request, if it is the second process to process the processing request, construct, through the second process, a response request corresponding to the processing request, where the response request includes an access address generated by the second process for accessing the target streaming media resource, feed back the response request to the first process, and feed back the response request to the client through the first process, to allow the client to establish a connection with the second process, and the target streaming media resource to be transmitted through the established connection.

In one embodiment, the system further includes a central node, where the central node includes at least a third process, and the third process is configured to, when the second process cannot process the processing request, receive the dispatched processing request and construct a response request corresponding to the processing request.

Specifically, the response request includes an access address generated by the third process for accessing the target streaming media resource, and the response request constructed by the third process is fed back to the second process, to allow the second process to establish a connection with the third process.

Correspondingly, the second process is further configured to rewrite the access address in the response request constructed by the third process to the access address generated by the second process, and feed back the response request with the rewritten access address to the client to allow the client to establish a connection with the second process.

In one embodiment, the central node further includes a fourth process, where the fourth process is configured to, when the third process cannot process the processing request, receive the processing request forwarded from the third process, and construct a response request corresponding to the processing request.

Specifically, the response request includes an access address generated by the fourth process for accessing the target streaming media resource, and the response request constructed by the fourth process is fed back to the second process through the third process, to allow the second process to establish a connection with the fourth process.

Correspondingly, the second process is further configured to rewrite the access address in the response request constructed by the fourth process to the access address generated by the second process, and feed back the response request with the written access address to the client to allow the client to establish a connection with the second process.

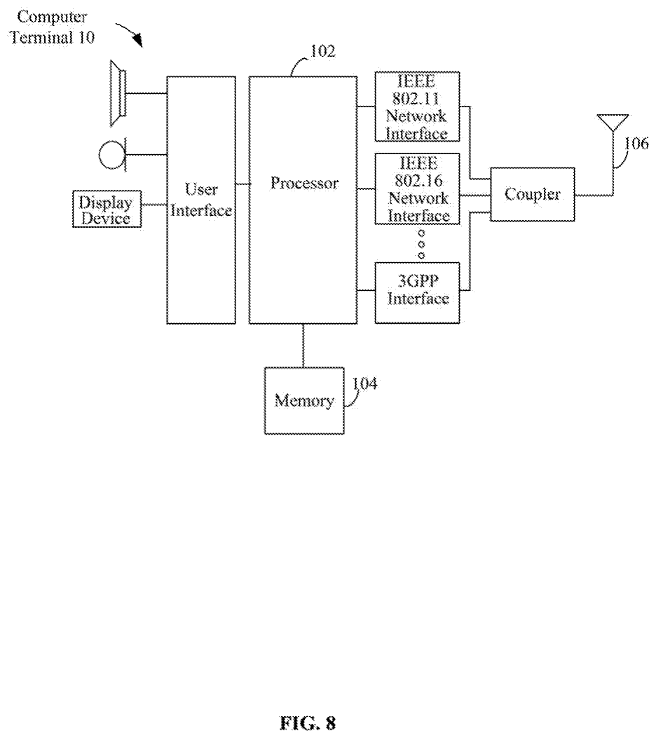

Referring to FIG. 8, in the present disclosure, the technical solutions of the disclosed embodiments may be applied to a computer terminal 10 shown in FIG. 8. The computer terminal 10 may include one or more (only one is shown in the figure) processors 102 (a processor 102 may include, but is not limited to, a processing device such as a micro-controller MCU or a programmable logic device FPGA), a memory 104 for storing data, and a transmission device 106 for communication purpose. It will be understood by those skilled in the art that the structure shown in FIG. 8 is provided by way of illustration, but not by way of limitation of the structures of the above-described electronic devices. For example, the computer terminal 10 may also include more or fewer components than those shown in FIG. 8, or have a different configuration than that shown in FIG. 8.

The memory 104 may be used to store software programs and modules of application software. The processor 102 implements various functional applications and data processing by executing software programs and modules stored in the memory 104. The memory 104 may include a high-speed random access memory, and also a non-volatile memory, such as one or more magnetic storage devices, flash memory, or other non-volatile solid-state memory. In some applications, the memory 104 may further include a memory remotely disposed with respect to the processor 102, which may be connected to the computer terminal 10 through a network. Examples of such network include, but are not limited to, the Internet, an intranet, a local area network, a mobile communication network, and combinations thereof.

The transmission device 106 is configured to receive or transmit data via the network. The aforementioned specific examples of the network may include a wireless network provided by the communication provider of the computer terminal 10. In one application, the transmission device 106 includes a network interface controller (NIC) that may be connected to other network devices through the base stations to allow it to communicate with the Internet. In one application, the transmission device 106 may be a Radio Frequency (RF) module that is configured to communicate with the Internet via a wireless approach.

As can be seen from the above, in the technical solutions provided by the present disclosure, the HTTP protocol and the WebRTC protocol may be integrated, which simplifies the process of establishing a communication connection, and can also adapt to the routing and forwarding regulations in the CDN. Multiple layers may be included in a CDN, such as an access layer (edge nodes), a relay layer (parent nodes), a core layer (source nodes), and the like. Routing or forwarding is usually involved within or between layers. Specifically, when a first process in a certain layer receives a processing request sent by a client, according to the routing rule in the CDN, it may be determined whether the processing request should be processed by the first process. If the processing request should not be processed by the first process, according to the routing rule, the processing request may be forwarded to a second process in the same layer. The second process may construct a response request for the processing request, where the response request may include an ICE candidate generated by the second process, and the ICE candidate may serve as an access address for accessing a target streaming media resource. After the response request is fed back to the client through the first process, a WebRTC communication connection may be established between the client and the second process. The client may upload the streaming media resource to the second process, or obtain the streaming media resource from the second process. Further, if the second process still cannot process the processing request, the processing request may be forwarded to a third process in a next layer. The third process may construct a response request in a similar manner, except that the access address included in the response request is generated by the third process. After the response request is fed back to the second process, the second process may rewrite the access address therein into its own access address, and feed back the response request with the rewritten access address to the client through the first process. In this way, the client and the second process, and the second process and the third process may respectively establish a WebRTC connection, and thus the streaming media resource can be transmitted. It can be seen that the technical solutions provided by the present disclosure may effectively combine the WebRTC standards with the CDN, which can utilize the fast distribution function of the CDN, while also achieving the low delay performance of the WebRTC, thereby improving the transmission efficiency of the streaming media resources.

Although the present disclosure has been described as above in term of preferred embodiments, these embodiments are not constructed as limiting the present disclosure. Any modifications, equivalent replacements, and improvements made without departing from the spirit and principle of the present disclosure shall fall within the scope of the protection of the present disclosure.

What is claimed is:

1. A method for transmitting streaming media resources, the method comprising:
receiving a processing request for a target streaming media resource sent by a client, and dispatching the processing request to a first process;
determining whether it is the first process to process the processing request, and if it is not the first process to process the processing request, forwarding the processing request to a second process in a layer in which the first process is located;
determining whether it is the second process to process the processing request, and if it is the second process to process the processing request, constructing, through the second process, a response request corresponding to the processing request, wherein the response request includes an access address generated by the second process for accessing the target streaming media resource; and
feeding back the response request to the first process, and feeding back the response request to the client through the first process, to allow the client to establish a connection with the second process, and the target streaming media resource to be transmitted through the established connection.

2. The method according to claim 1, wherein the processing request includes a resource acquisition request, and determining whether it is the first process to process the processing request further includes:
determining whether the target streaming media resource is included in a local resource associated with the first process, if the target streaming media resource is included in the local resource associated with the first process, determining that it is the first process to process the processing request, and if the target streaming media resource is not included in the local resource associated with the first process, determining that it is not the first process to process the processing request.

3. The method according to claim 1, wherein the processing request includes a resource uploading request, and the resource uploading request includes a unique identifier of the target streaming media resource, and determining whether it is the first process to process the processing request further includes:
calculating a hash value corresponding to the unique identifier, and determining whether the hash value signifies the first process, if the hash value signifies the first process, determining that it is the first process to process the processing request, and if the hash value does not signify the first process, determining that it is not the first process to process the processing request.

4. The method according to claim 1, wherein the processing request includes a resource uploading request, the resource uploading request includes candidate streaming media information supported by the client, and the response request further includes response streaming media information generated by the second process based on the candidate streaming media information, and transmitting the target streaming media resource through the established connection further includes:
processing, by the client, the target streaming media resource according to the response streaming media information, and uploading the processed target streaming media resource to the second process according to the access address.

5. The method according to claim 1, wherein the processing request includes a resource acquisition request, the resource acquisition request includes a unique identifier of the target streaming media resource, and the response request further includes target streaming media information associated with the target streaming media resource, and transmitting the target streaming media resource through the established connection further includes:
downloading, by the client, the target streaming media resource through the access address, and processing the downloaded target streaming media resource according to the target streaming media information.

6. The method of claim 1, wherein generating the access address by the second process further includes:
obtaining, by the second process, public network IP address and port address of the second process, and using a combination of the public network IP address and the port address of the second process as the access address for accessing the target streaming media resource.

7. The method of claim 1, further comprising:
if the second process cannot process the processing request, dispatching the processing request to a third process, wherein the third process and the second process are located in different layers of a content delivery network;
determining whether it is the third process to process the processing request, if it is the third process to process the processing request, constructing, through the third process, a response request corresponding to the processing request, wherein the response request includes an access address generated by the third process for accessing the target streaming media resource;
feeding back the response request constructed by the third process to the second process, to allow the second process to establish a connection with the third process;
rewriting, through the second process, the access address in the response request constructed by the third process to the access address generated by the second process, and feeding back a response request with the rewritten access address to the client, to allow the client to establish a connection with the second process; and
transmitting the target streaming media resource through the connection established between the client and the second process and the connection established between the second process and the third process.

8. The method according to claim 7, wherein the processing request includes a resource uploading request, and the resource uploading request includes candidate streaming media information supported by the client, and constructing, by the third process, the response request corresponding to the processing request further includes:
generating, by the third process, response streaming media information based on the candidate streaming media information;
obtaining, by the third process, public network IP address and port address of the third process, and using a combination of the public network IP address and the port address of the third process as the access address for accessing the target streaming media resource; and
constructing, by the third process, the response request, and using the response streaming media information and the access address generated by the third process as a response message body of the response request.

9. The method according to claim 8, wherein transmitting the target streaming media resource further includes:
processing, by the client, the target streaming media resource according to the response streaming media information, and uploading the processed target streaming media resource to the second process according to the access address generated by the second process;
associating and storing, by the second process, the processed target streaming media resource with the response streaming media information, and uploading the processed target streaming media resource to the third process according to the access address generated by the third process; and
associating and storing, by the third process, the processed target streaming media resource with the response streaming media information.

10. The method according to claim 7, wherein the processing request includes a resource acquisition request, and the resource acquisition request includes a unique identifier of the target streaming media resource; and constructing, by the third process, the response request corresponding to the processing request further includes:
obtaining, by the third process, target streaming media information associated with the unique identifier;
obtaining, by the third process, public network IP address and port address of the third process, and using a combination of the public network IP address and the port address of the third process as the access address for accessing the target streaming media resource; and
constructing, by the third process, the response request, and using the target streaming media information and the access address generated by the third process as a response message body of the response request.

11. The method of claim 10, wherein transmitting the target streaming media resource further includes:
downloading, by the second process, the target streaming media resource from the third process according to the access address generated by the third process, and associating and storing the downloaded target streaming media resource with the target streaming media information; and
downloading, by the client, the target streaming media resource from the second process according to the access address generated by the second process.

12. The method of claim 7, further comprising:
if the third process cannot process the processing request, forwarding the processing request to a fourth process at a same layer as the third process, to allow the fourth process to construct a response request corresponding to the processing request, wherein the response request includes an access address generated by the fourth process for accessing the target streaming media resource;
feeding back, through the third process, the response request constructed by the fourth process to the second process, to allow the second process to establish a connection with the fourth process;
rewriting, by the second process, the access address in the response request constructed by the fourth process to the access address generated by the second process, and feeding back a response request with the rewritten access address to the client, to allow the client to establish a connection with the second process; and
transmitting the target streaming media resource through the connection established between the client and the second process and the connection established between the second process and the fourth process.

13. A system for transmitting streaming media resources, comprising a client and an edge node, wherein:
the client is configured to send a processing request for a target streaming media resource to the edge node; and
the edge node is configured to:
dispatch the processing request to a first process, determine whether it is the first process to process the processing request, if it is not the first process to process the processing request, forward the processing request to a second process in a layer in which the first process is located, determine whether it is the second process to process the processing request, if it is the second process to process the processing request, construct, through the second process, a response request corresponding to the processing request, wherein the response request includes an access address generated by the second process for accessing the target streaming media resource, feed back the response request to the first process, and feed back the response request to the client through the first process, to allow the client to establish a connection with the second process, and the target streaming media resource to be transmitted through the established connection.

14. The system according to claim 13, further comprising a central node, wherein the central node includes at least a third process, and the third process is configured to, when the second process cannot process the processing request, receive the dispatched processing request and construct a response request corresponding to the processing request.

15. The system according to claim 14, wherein the response request includes an access address generated by the third process for accessing the target streaming media resource, and the response request constructed by the third process is fed back to the second process to allow the second process to establish a connection with the third process; and
the second process is further configured to rewrite the access address in the response request constructed by the third process into the access address generated by the second process, and feed back a response request with the rewritten access address to the client, to allow the client to establish a connection with the second process.

16. The system according to claim 14, wherein the central node further includes a fourth process, and the fourth process is configured to receive the processing request forwarded by the third process when the third process cannot process the processing request, and construct a response request corresponding to the processing request.

17. The system according to claim 16, wherein the response request includes an access address generated by the fourth process for accessing the target streaming media resource, and the response request constructed by the fourth process is fed back to the second process through the third process, to allow the second process to establish a connection with the fourth process; and
the second process is further configured to rewrite the access address in the response request constructed by the fourth process to the access address generated by the second process, and feed back a response request with the rewritten access address to the client, to allow the client to establish a connection with the second process.
